(19) United States
(12) Patent Application Publication
(10) Pub. No.: US 2021/0083335 A1
(43) Pub. Date: Mar. 18, 2021

(54) BATTERY-BASED SYSTEM FOR POWERING REFRIGERATED TRANSPORT AND OTHER INDUSTRIAL APPLICATIONS

(71) Applicants: Transchill, LLC, Logan, UT (US); Utah State University, Logan, UT (US)

(72) Inventors: Bahman SADEGHI, Logan, UT (US); Michael J MORLEY, Amalga, UT (US); Regan Andrew ZANE, Hyde Park, UT (US); Rees Randall HATCH, Woodstock, GA (US); Ryan BOHM, Logan, UT (US)

(73) Assignees: Transchill, LLC, Logan, UT (US); Utah State University, Logan, UT (US)

(21) Appl. No.: 17/018,990

(22) Filed: Sep. 11, 2020

Related U.S. Application Data
(60) Provisional application No. 62/900,452, filed on Sep. 13, 2019.

(51) Int. Cl. H01M 10/42; F25B 27/00; B60H 1/00

(52) U.S. Cl. CPC H01M 10/4257; F25B 27/00; H01M 2010/4271; H01M 2220/10; B60H 1/00378

(57) ABSTRACT

The invention relates to a battery-based system for powering refrigerated transport and other industrial applications. It includes a battery-based system for supplying power comprising a housing encasing a battery unit, a battery management system connected to the battery unit and operable to manage battery unit, and a power management unit connected to the battery unit and operable to convert battery power from the battery unit to 3 phase power of between 380 and 480 Vac. One exemplary application of the invention is to replace diesel gen-sets in refrigerated transport with more reliable and reduced emission battery power.

### RELATED APPLICATION

This application is the non-provisional for U.S. Provisional Patent Application 62/900,452 filed on Sep. 13, 2019, claims priority thereto, and incorporates the same as if fully set forth herein.

### BACKGROUND OF THE INVENTION

Refrigerated transport is critical in modern shipping systems and economies. This specialized type of transport may be carried out by vans, trucks, and/or refrigerated shipping containers (or “reefers”) carrying perishable freight at specific temperatures. In 2010 alone, there were around four (4) million such vehicles in use worldwide. In most cases, vehicles and/or containers are equipped with mechanical refrigeration systems powered by small displacement diesel or other combustion engines known as gen-sets. However, the use of these engines to achieve refrigeration presents a number of problems.

For example, engines with moving parts are subject to wear and tear and mechanical failure that requires periodic (and sometimes frequent) maintenance or replacement as the system ages. Engine failures may result in damage or destruction to perishable cargo, as well as transport downtime, delayed or missed delivery, and lost profits. Moreover, engines increase undesirable combustion emissions—a health and safety problem that may be compounded by increased traffic and transport at or near population centers.

What is needed is a new type of power system for refrigerated transport and other industrial applications that minimizes maintenance, optimizes reliability, and reduces or eliminates undesirable emissions.

### SUMMARY OF THE INVENTION

In accordance with the above, a new and innovative battery-based system for powering refrigerated transport and other industrial applications is provided.

These and other aspects of the present invention will become more fully apparent from the following description and appended claim, or they may be learned by the practice of the invention as set forth hereinafter. The invention includes a battery-based system for supplying power comprising a housing encasing a battery unit, battery management system connected to the battery unit and operable to manage battery unit, and a power management unit connected to the battery unit and operable to convert battery power from the battery unit to 3 phase power of between 380 and 480 Vac.

### BRIEF DESCRIPTION OF THE FIGURES

To further clarify the above and other aspects of the present invention, a more particular description of the invention will be rendered by reference to specific embodiments thereof which are illustrated in the appended drawings. It is appreciated that these drawings depict only typical embodiments of the invention and are therefore not to be considered limiting of its scope. The drawings may not be drawn to scale. The invention will be described and explained with additional specificity and detail through the use of the accompanying drawings in which:

FIG. 1 is a perspective view of one embodiment of a battery-based system for powering refrigerated transport and other industrial applications.

FIG. 2 is a block diagram of major subsystems of one embodiment of a battery-based system for powering refrigerated transport and other industrial applications.

FIG. 3 is a top view of one embodiment of a battery-based system for powering refrigerated transport and other industrial applications.

FIG. 4 is a top view of a portion of a battery-based system for powering refrigerated transport and other industrial applications that includes a battery management subsystem.

FIG. 5 is a top view of a portion of a battery-based system for powering refrigerated transport and other industrial applications that includes a power management subsystem.

FIG. 6 is a top view of a portion of a battery-based system for powering refrigerated transport and other industrial applications that includes a charging subsystem.

FIG. 7 is a view of a portion of a cooling/heating subsystem in one embodiment of a battery-based system for powering refrigerated transport and other industrial applications.

FIG. 8 is a view of a portion of a control subsystem in one embodiment of a battery-based system for powering refrigerated transport and other industrial applications that includes a user interface.

FIG. 9 is a view of a wiring/interconnect chart for one embodiment of a battery-based system for powering refrigerated transport and other industrial applications.

FIG. 10 is a block diagram of a computer with memory and modules for one embodiment of a battery-based system for powering refrigerated transport and other industrial applications.

FIG. 11 is a first performance chart of one embodiment of a battery-based system for powering refrigerated transport and other industrial applications.

FIG. 12 is a second performance chart of one embodiment of a battery-based system for powering refrigerated transport and other industrial applications.

FIG. 13 is a is a first cost savings chart related to one embodiment of a battery-based system for powering refrigerated transport and other industrial applications.

FIG. 14 is a is a second cost savings chart related to one embodiment of a battery-based system for powering refrigerated transport and other industrial applications.

FIG. 15 is a is a third cost savings chart related to one embodiment of a battery-based system for powering refrigerated transport and other industrial applications.

### DETAILED DESCRIPTION OF THE ILLUSTRATED EMBODIMENT

The present invention in its various embodiments, some of which are depicted in the figures herein, is a battery-based system for powering refrigerated transport or other industrial equipment requiring three phase power.

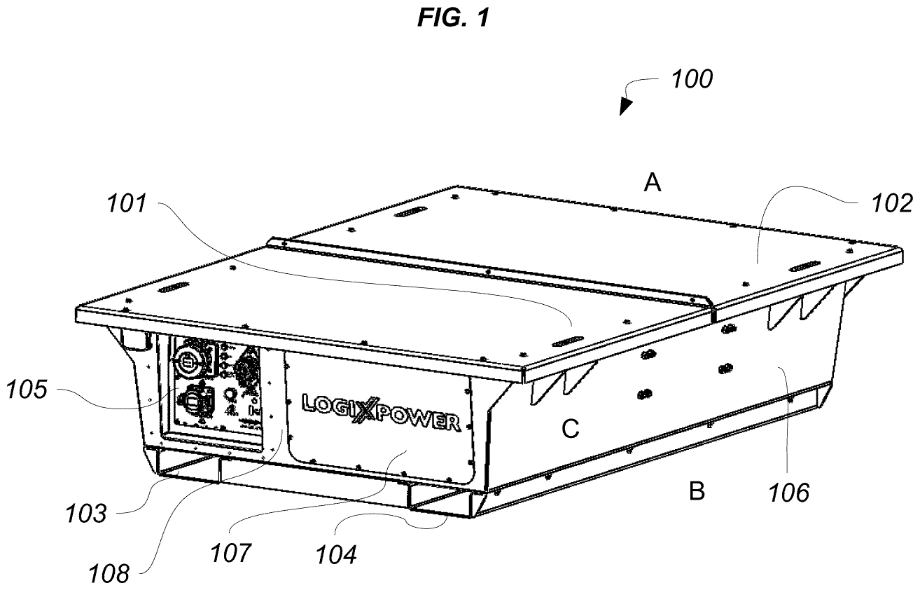

Referring now to FIG. 1, an exemplary battery-based system for powering refrigerated transport 100 is shown. System 100 may comprise an enclosed or encased, generally rectangular six-sided housing with one or more access doors 101, 102, forklift mounts 103, 104, user interface 105, and subsystems and/or components as further described below. In the illustrated embodiment, system 100 is dimensioned between 48 and 53 inches wide A, 70 to 80 inches long B, and 15 to 20 inches high C. One specific embodiment may be 52.8 inches wide, 70.6 inches long, and 18.2 inches high. The system 100 of the illustrated embodiment is specifically configured to replace a bottom mount gen set (diesel powered generator) for a reefer truck, although the system 100 can be alternatively configured for any number of other applications.

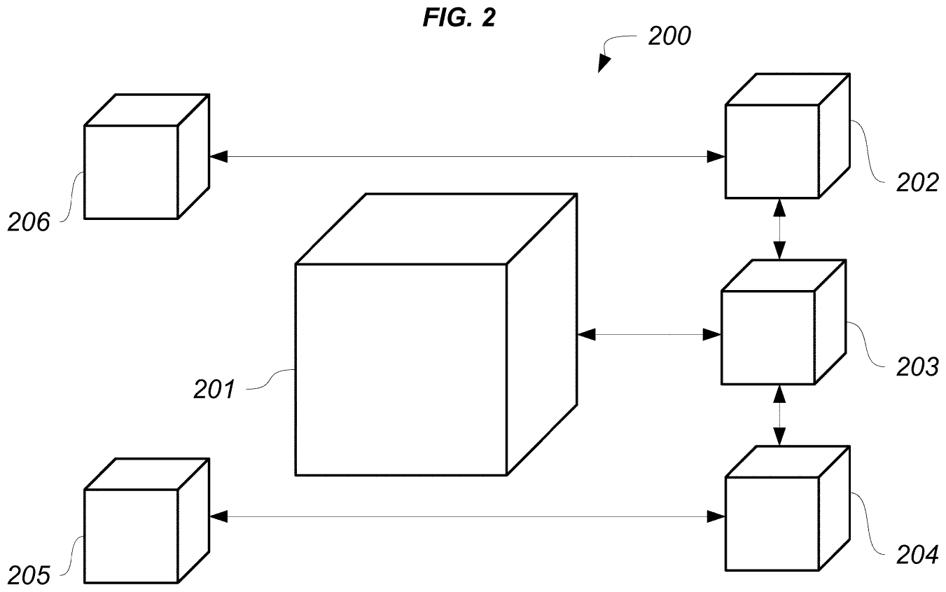

Referring now to FIG. 2, a block diagram 200 showing major subsystems and/or components is shown. System 100 may comprise subsystems and/or components including a battery unit 201, battery management system 202, power management unit 203, control system 204, cooling and heating system 205, and charging system 206. Each of the above subsystems and/or components is connected to and in communication with the other to achieve the various functions and performance described in more detail below. Specific system configuration, including but not limited to housing design, on-board charger, heating, may vary by embodiment or application.

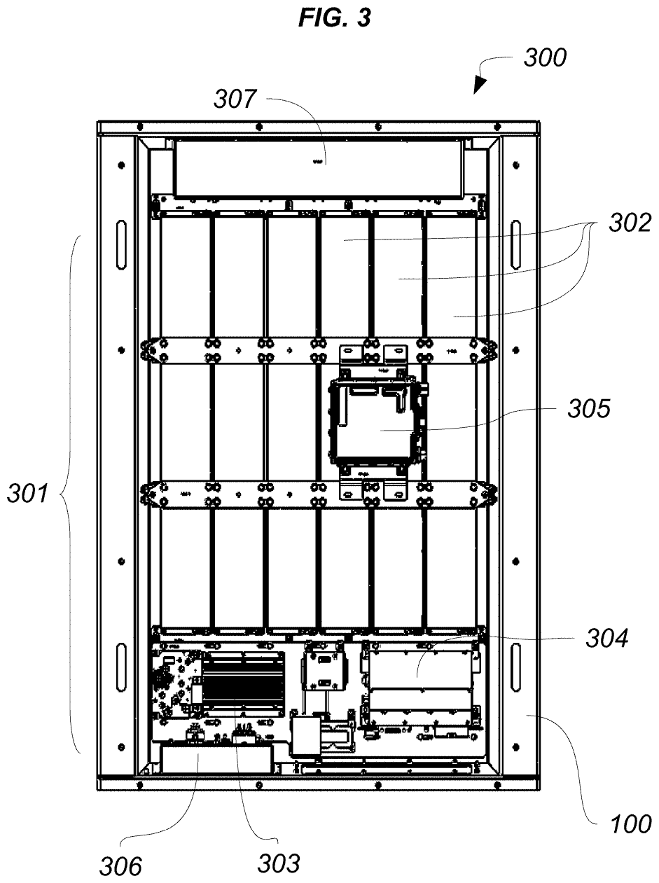

Referring now to FIG. 3, a battery unit 301 in one embodiment of a battery-based system 300 is shown. Battery unit 301 is comprised of a plurality of battery cells (shown grouped) 302. In preferred embodiments, battery cells are lithium ion—and may range between 70 amp/hrs, 100 amp/hrs, and 120 amp/hrs, depending on the desired application of the system 100. The battery unit 301 of the illustrated embodiment uses 108 to 180 cells in series to generate approximately 400-800 Vdc. In preferred embodiments, the number and type of batteries used are selected based on a desired and/or predetermined power output, for example, six (6) to thirty-six (36) or forty-eight (48) hours of output at ˜400 Vac. However, any number of amp/hrs cells, battery types, configurations, and/or output targets may be used without departing from the purpose and scope of the invention. Across embodiments, battery units may also be stacked in one, two, or more layers to achieve increased or customized capacity in the system 100. For reference, FIG. 3 also shows the locations and connections of the following subsystems in the illustrated embodiment: a battery management system 303, a power management system 304, a charging system 305, control system 306, and heating/cooling system 307.

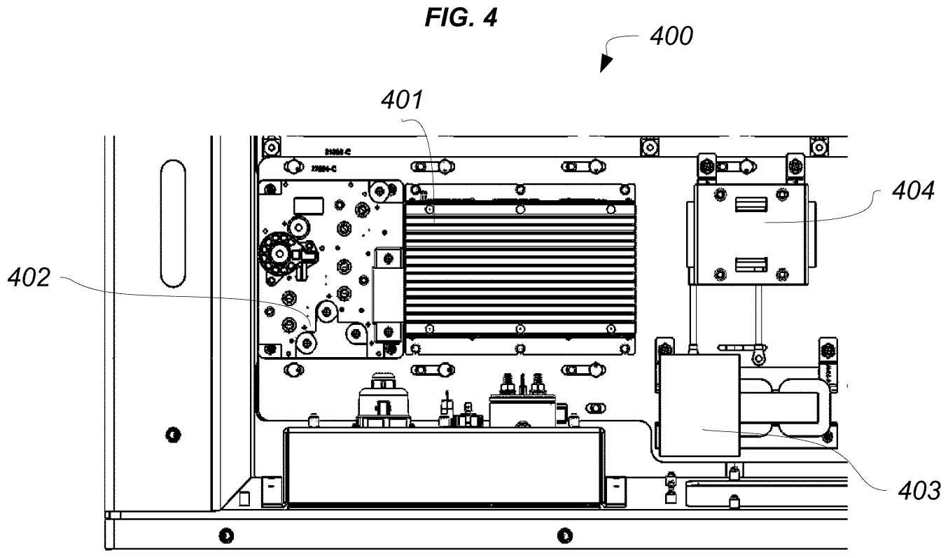

Referring now to FIG. 4, a battery management system 401 is shown. Battery management system 401 may include one or more printed circuit boards, controllers, power supplies, relays, fuses, and electronic components. Battery management system 401 manages the battery unit 301 through functions such as protecting batteries from operating outside safe operating area, monitoring state, calculating secondary data, reporting that data, controlling the battery environment, and balancing the battery unit 301. Battery management system 401 may be of many types and/or varieties, including off-the-shelf components; one example is the Orion Brand BMS by Evert Energy Systems. For reference, FIG. 4 also shows the locations and connections of the following components in the illustrated embodiment: a high voltage interface module 402, AC filter 403, and inductor coil 404.

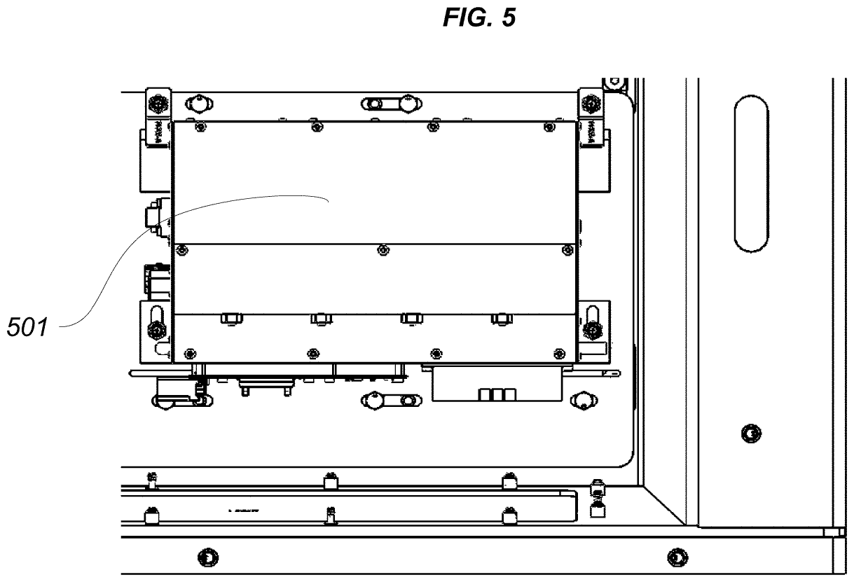

Referring now to FIG. 5, a power management unit (PMU) 501 is shown. PMU 501 may be comprised of one or more circuit boards 502; capacitors 503, 504; coils 505, and filters 403. In operation, the PMU 501 takes power from the battery unit 301 through the coil 505, and boosts the voltage across a busbar to a potential ˜700 Vdc. Circuit board 502 contains modules for power conversion, including IGBT and/or silicon carbide or “MOSFET” switches to boost battery potential to achieve a first conversion from, for example, 400 Vdc to 700 Vdc, and to achieve a second conversion from 700 Vdc to 3 phase 480 Vsquare or triangular waveform. The complex proprietary software algorithms and programs control the switching to produce the desired output wave forms. Output filter 403 smooths the waveform to a sinusoidal waveform at 380-480 Vac, the typical power required by transport refrigeration systems and other industrial machines.

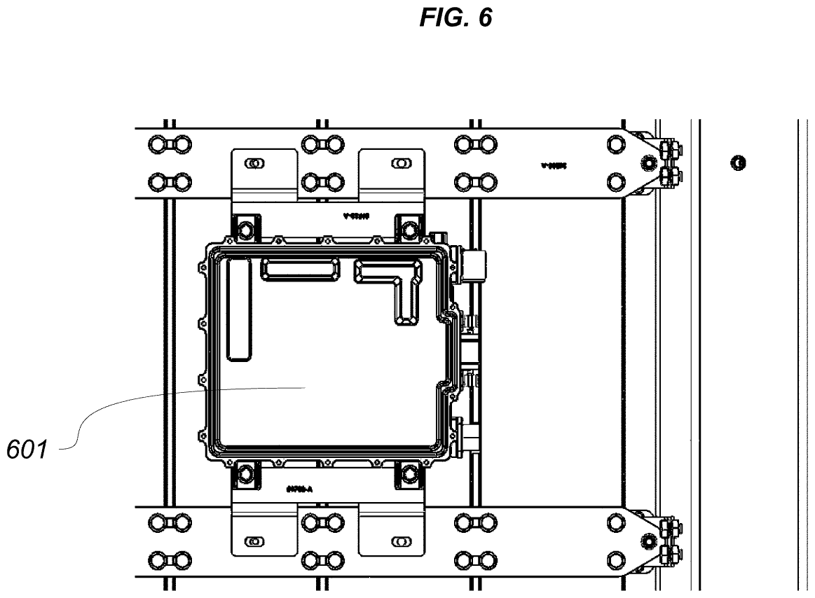

Referring now to FIG. 6, charging system 601 is shown. There are several options for charging the batteries. All options include a charger and an electric vehicle supply equipment (EVSE). The EVSE provides communication between the supply power and the charger and manages the safety of the charging. The charger can be included within the system 100 enclosure or be external to the enclosure. The size and output of the charging system is determined by the customer requirements. Chargers with larger output capacity are more expensive and charge the batteries more quickly than the smaller capacity chargers.

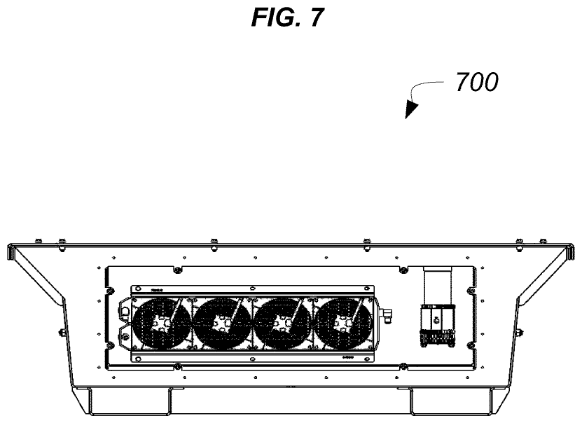

Referring now to FIG. 7, cooling/heating system 700 is shown. The cooling system is necessary to keep the high-powered switches within safe operating temperatures regardless of the environmental conditions. The cooling system is a sealed water-based system comprised of heat transfer plates, pump, radiator, fans and tubing. The heating option is for operation in freezing conditions. The Li-Ion batteries can be damaged when charging in temperatures below freezing. A heating element is added to the tubing to warm the batteries to within safe operating range to allow for safe charging of the batteries.

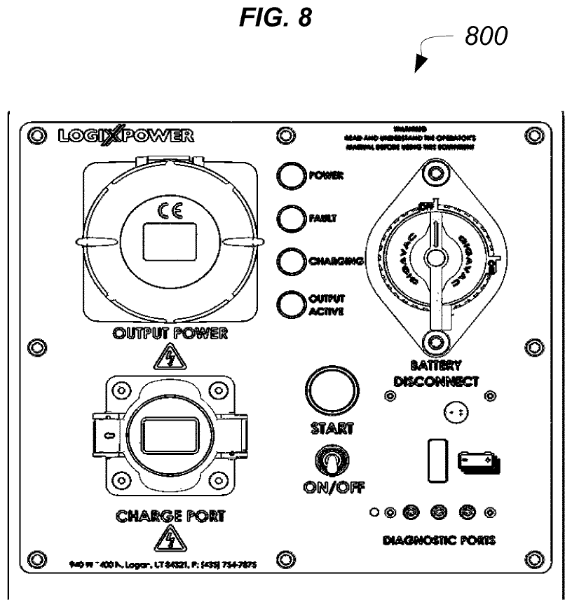

Referring now to FIG. 8, the user interface 800 for the control system 306 is shown. The control system 306 is comprised of one or more custom circuit boards. The circuit boards contain proprietary software running on the processors to control the relays, switches and various electronic components that provide the logic that manages the safety features, charging and general operation of the system 100.

In various embodiments, battery-based system for refrigerated transport and other industrial applications 100 includes additional functionality and/or features. For example, the system 100 includes asset tracking and performance data functionality (via, e.g., IOT, Internet of Things) by incorporating one or more processors with memory, communication modules, GPS receiver, accelerometers and modes for reporting system status and/or management. Moreover, system 100 may also incorporate a wireless or solar charging capabilities.

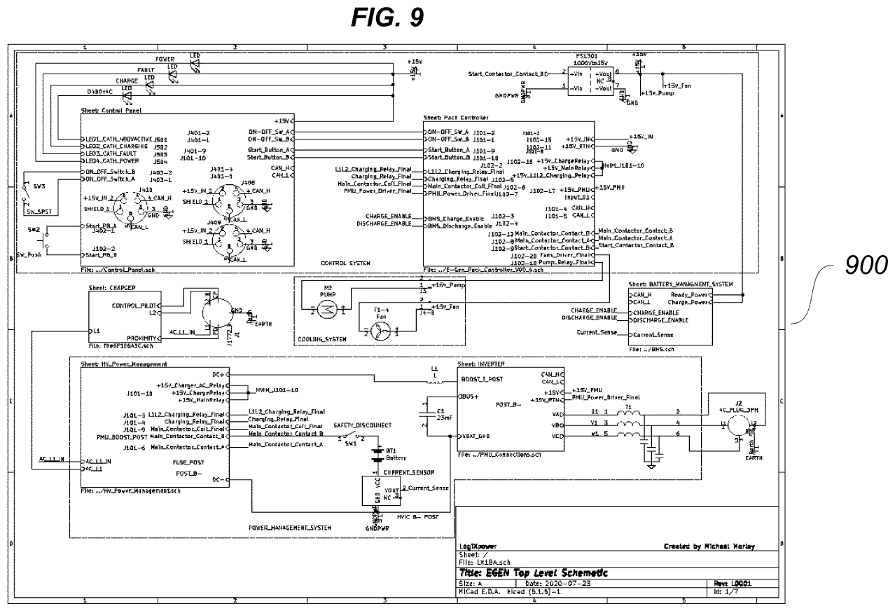

Referring now to FIG. 9, an exemplary wiring/interconnect chart for the illustrated embodiment of the system 100 is shown. Alternative wiring and/or interconnections may be used in other embodiments without departing from the purposes or scope of the invention.

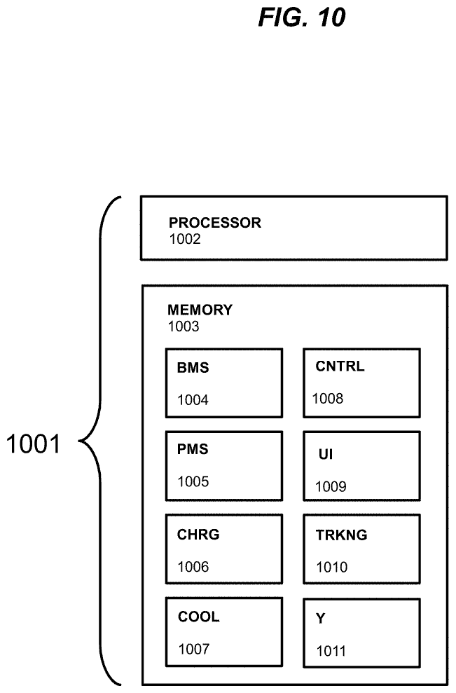

Referring now to FIG. 10, a block diagram of a computer with memory and modules for one embodiment of a battery-based system for powering refrigerated transport and other industrial applications. Referring now to FIG. 10, a computer 1001 with processor 1002 and memory 1003 may contain one or more modules to commence operation of, operate, and/or cease operation of the battery-based system and functionality and modes thereof. For example, memory 1003 may include a module: (1) for communicating with, operating and/or running the routines of the battery management system 1004; (2) for communicating with, operating and/or running the routines of the power management system 1005; (3) for communicating with, operating and/or running the routines of the charging system 1006; (4) for communicating with, operating and/or running the routines of the cooling/heating system 1007; (5) for communicating with, operating and/or running the routines of the control system 1008; (6) for communicating with, operating and/or running the routines of the user interface 1009; and/or for communicating with, operating and/or running the routines of the tracking system 1010. Some or all of these operations may be described above and are incorporated herein.

So configured, battery-based system for refrigerated transport and other industrial applications 100 provides for a battery pack with a relatively larger number of batteries generally designed to supply power over a longer period of time than the type of battery systems seen in other applications, e.g., to power vehicles. The system's capacity range is preferably Output voltage of 480 volts and/or 100 Amps for between 12 and 48 hours.

The system 100 provides a number of other advantages over existing solutions. Again, one embodiment of the system 100 is specifically configured to replace existing small displacement diesel or other combustion engines used to power transport refrigeration units and other industrial applications. Preferred embodiments of this type are around 1,200 pounds—lighter weight than traditional diesel gen-sets (˜1,800 pounds). Moreover, electrical power cost may be 25% that of comparable diesel power. Such system 100 is environmentally friendly by not using liquid fuel, resulting emissions, and achieving little or no noise pollution. The charge time of the exemplified system is between 1.5 and 4 hours. Moreover, the illustrated system 100 can recharge for up to 1500 cycles.

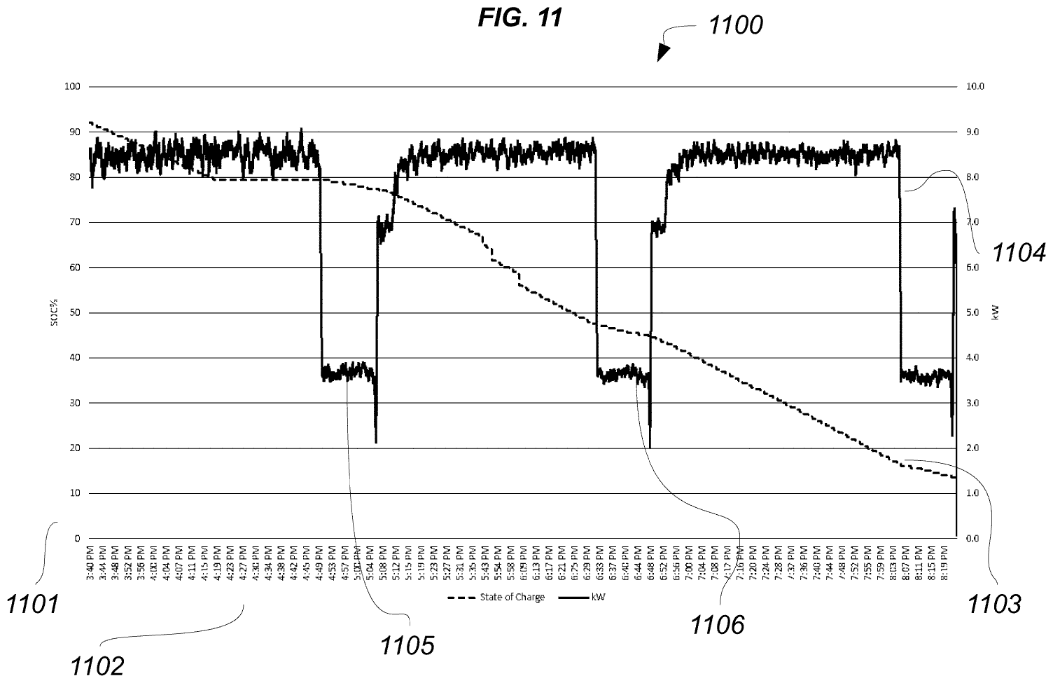

Referring now to FIG. 11, a first performance chart 1100 for one embodiment of the system is shown. Chart 1100 represents a full load on the system with continuous operation, little or no cold retention, and the refrigeration compressor running continuously interrupted only by defrost cycles 1105, 1106. On chart 1100, the Y axis 1101 represents: (a) to the left and with the dashed line 1103, the state of charge (SOC) or level of charge of the system relative to its capacity as a percentage; and (b) to the right and with the solid line 1106 the kilowatt output of the system. The X axis 1102 represents time lapse. Chart 1100 demonstrates exemplary SOC and output for one embodiment of the system under the conditions described over a period of approximately 4.5 hours.

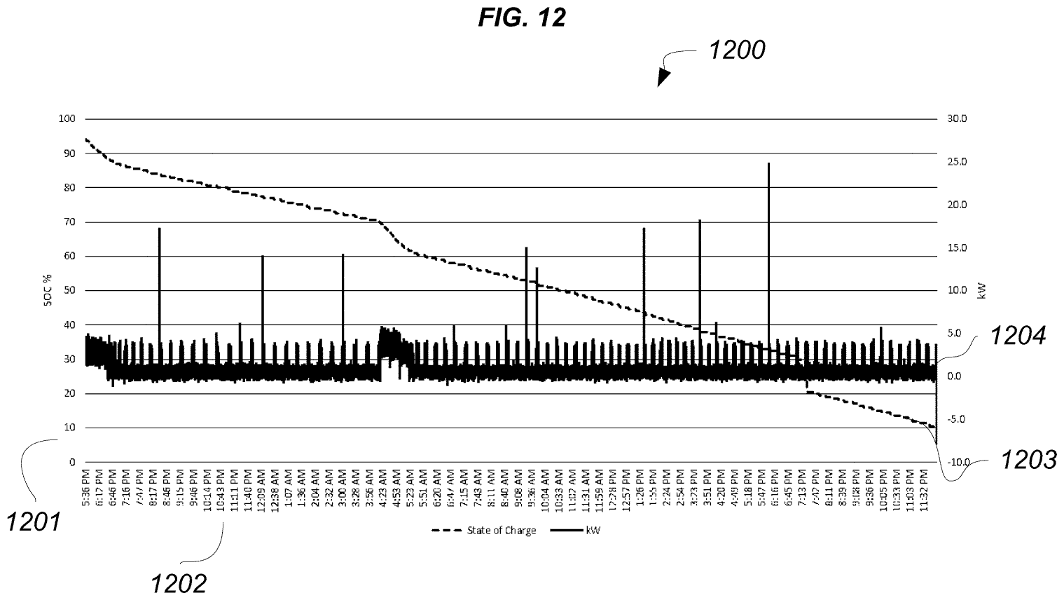

Referring now to FIG. 12, a second performance chart 1200 for one embodiment of the system is shown. Chart 1200 represents a partial load on the system, continuous operation, with temperature maintained at forty (40) degrees in a simulated reefer truck env. On chart 1200, the Y axis 1201 again represents: (a) to the left and with the dashed line 1203, the state of charge (SOC) as a percentage; and (b) to the right and with the solid line 1204 the kilowatt output of the system. The X axis 1202 represents time lapse. Chart 1200 demonstrates exemplary SOC and output for one embodiment of the system under the conditions described over a period of approximately thirty (30) hours.

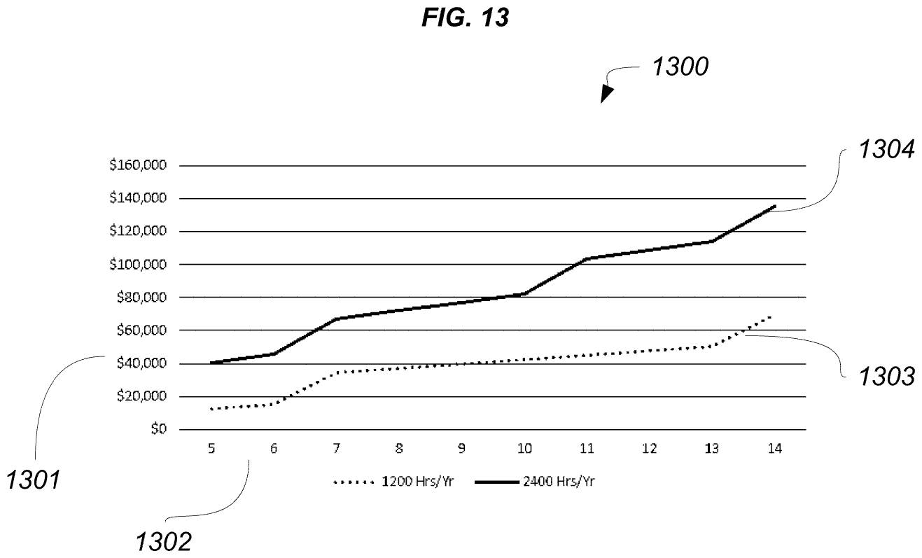

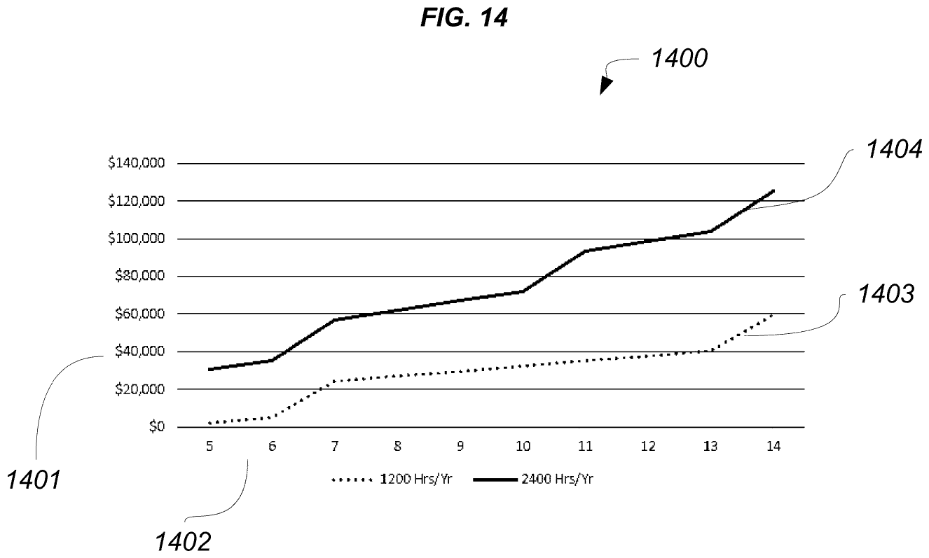

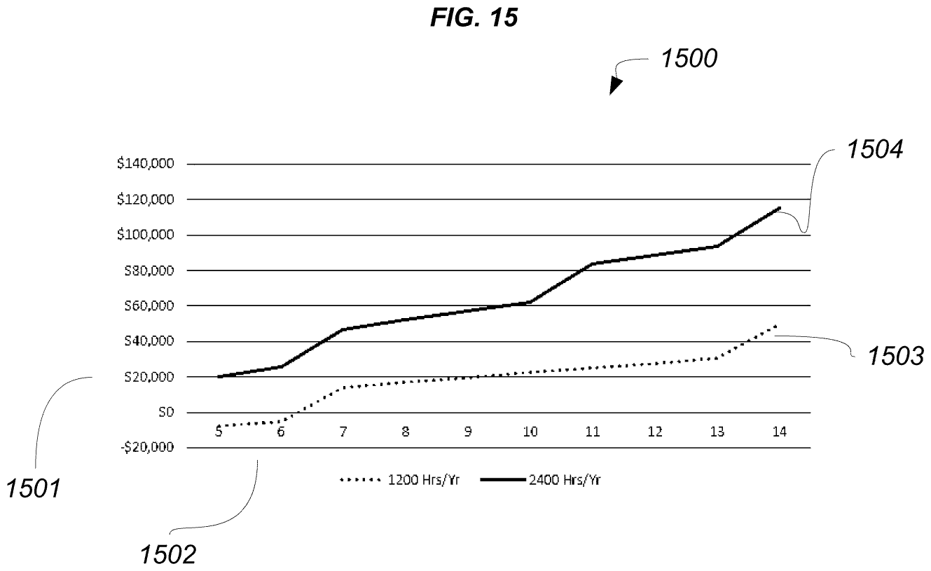

Referring now to FIGS. 13-15, various exemplary cost savings charts are shown for the system compared to the costs of a diesel gen-set over fixed time periods of 12, 24, and 36 hour runs at a total usage of 1200 and 2400 hours per year. For example, the chart 1300 of FIG. 13 shows, on the Y axis 1301 amount of dollars in cost savings, and on the X axis 1302 the number of years, assuming 12 hour run time. A first line 1303 represents cost savings for 1200 hours per year system operation, and a second line 1304 represents cost savings for 2400 hours a year. The chart of FIG. 14 shows, on the Y axis 1401 amount of dollars in cost savings, and on the X axis 1402 the number of years, assuming 24 hour run time. A first line 1403 represents cost savings for 1200 hours per year system operation, and a second line 1404 represents cost savings for 2400 hours a year. Finally, the chart of FIG. 15 shows, on the Y axis 1501 amount of dollars in cost savings, and on the X axis 1502 the number of years, assuming 36 hour run time. A first line 1503 represents cost savings for 1200 hours per year system operation, and a second line 1504 represents cost savings for 2400 hours a year. Given a scenario of 24 hour runs at 1200 hours a year for 10 years, the total cost advantage of the system is around $40,500 per unit. Consequently, a fleet of 100 vehicles may save over $4,000,000 over a 10-year period by using the system instead of a diesel gen-set.

So configured, among other features the invention described above provides for a battery-based system with a battery unit, battery management system, and power management unit all configured to power a refrigeration unit for refrigerated transport and other industrial applications. For refrigerated transport systems and other industrial applications, the battery-based system minimizes maintenance, optimizes reliability, and reduces or eliminates undesirable emissions.

The present invention may be embodied in other specific forms without departing from its spirit or essential characteristics. The described embodiments are to be considered in all respects only as illustrative and not restrictive. The scope of the invention is, therefore, indicated by the appended claims rather than by the foregoing description. All changes which come within the meaning and range of equivalency of the claims are to be embraced within their scope.

We claim:

1. A battery-based system for supplying power comprising:
a housing encasing
a battery unit;
a battery management system connected to the battery unit and operable to manage the battery unit; and
a power management unit connected to the battery unit and operable to convert battery power from the battery unit to 3 phase power of between 380 and 480 Vac.

2. The battery-based system for supplying power of claim 1, further configured to provide 3 phase power of between 380 and 480 Vac for a period of between six and forty-eight hours on a full charge.

3. The battery-based system for supplying power of claim 1, the battery-based system configured as an aftermarket part to replace a diesel gen-set.

4. The battery-based system for supplying power of claim 1, the battery-based system further configured to be the primary power source for an industrial appliance.

5. The battery-based system for supplying power of claim 1, the battery-based system further configured to be the sole power source for an industrial appliance.

6. The battery-based system for supplying power of claim 1, further comprising a heating and cooling system for regulating temperature within the housing.

7. The battery-based system for supplying power of claim 1, further comprising a means for recharging the battery unit.

8. A battery-based system for powering refrigerated transport comprising:
a housing encasing
a battery unit
a battery management system connected to the battery unit and operable to manage the battery unit; and
a power management unit connected to the battery unit and operable to convert battery power from the battery unit to 3 phase power of between 380 and 480 Vac.

9. The battery-based system for powering refrigerated transport of claim 8, the battery-based system further configured to provide 3 phase power of between 380 and 480 Vac for a period of between six and forty-eight hours on a full charge.

10. The battery-based system for powering refrigerated transport of claim 8, the battery-based system further configured to replace a diesel gen-set.

11. The battery-based system for powering refrigerated transport of claim 8, the battery-based system further configured to be the primary power source for a transport refrigeration unit.

12. The battery-based system for powering refrigerated transport of claim 8, the battery-based system further configured to be the sole power source for a transport refrigeration unit.

13. The battery-based system for powering refrigerated transport of claim 8, the housing further encasing a heating and cooling system for regulating temperature within the battery-based system.

14. The battery-based system for powering refrigerated transport of claim 8, the battery-based system further comprising a means for recharging the battery unit.

15. A battery-based system for powering refrigerated transport comprising:
a housing configured to replace a diesel gen-set on a transport vehicle, the housing encasing
a battery unit;
a battery management system connected to the battery unit and operable to manage the battery unit;
a power management unit connected to the battery unit and operable to convert battery power from the battery unit to 3 phase power of between 380 and 480 Vac;
a heating and cooling system for regulating temperature within the battery-based system; and
means for recharging the battery unit;
the battery-based system further configured to provide 3 phase power of between 380 and 480 Vac for a period of between six and forty-eight hours on a full charge.

16. The battery-based system for supplying power of claim 15, the battery-based system further configured to be the sole power source for a transport refrigeration unit.

17. The battery-based system for supplying power of claim 15, further comprising a computer with memory that contains a module for performing asset tracking and reporting battery-based system performance data.

18. The battery-based system for powering refrigerated transport of claim 15, the battery-based system weighing less than 1,500 pounds.

19. The battery-based system for powering refrigerated transport of claim 15, the battery unit comprised of between 108 and 180 lithium ion cells, from one of 70 amp/hrs, 100 amp/hrs, and 120 amp/hrs, arranged in series.

20. The battery-based system for powering refrigerated transport of claim 15, the housing further having a user interface connected to a control system for allowing a user to operate the battery-based system.
